(19) United States
(12) Patent Application Publication
(10) Pub. No.: US 2015/0241378 A1
(43) Pub. Date: Aug. 27, 2015

(54) ELECTROCHEMICAL-BASED ANALYTICAL TEST STRIP WITH BARE INTERFERENT ELECTRODES

(71) Applicant: LIFESCAN SCOTLAND LIMITED, Inverness (GB)

(72) Inventors: Zuifang Liu, Inverness (GB); Anna Salgado, Inverness (GB); Gavin Macfie, Inverness (GB); Damian Baskeyfield, Inverness (GB); Stuart Phillips, Inverness (GB)

(21) Appl. No.: 14/426,542

(22) PCT Filed: Sep. 9, 2013
(86) PCT No.: PCT/GB2013/052354

§ 371 Date: Mar. 6, 2015

(30) Foreign Application Priority Data
Sep. 7, 2012 (GB) 1216031.3

(51) Int. Cl. G01N 27/327

(52) U.S. Cl. CPC G01N 27/3272

(57) ABSTRACT

An electrochemical-based analytical test strip (“TS”) for the determination of an analyte in a bodily fluid sample includes an electrically insulating substrate, a patterned conductor layer disposed over the electrically-insulating substrate and having an analyte working electrode (“WE”), a bare interferent electrode (“IE”) and a shared counter/reference electrode (“CE”). The TS also includes a patterned insulation layer (“PIL”) with an electrode exposure slot configured to expose the WE, IE and CE, an enzymatic reagent layer disposed on the WE and CE, and a patterned spacer layer (“PSL”). The PIL and the PSL define a sample receiving chamber with a sample-receiving opening. The IE and the CE constitute a first electrode pair configured for measurement of an interferent electrochemical response and the WE and the CE constitute a second electrode pair configured for measurement of an analyte electrochemical response. The WE and the IE are electrically isolated from one another.

### FIELD OF THE INVENTION

The present invention relates, in general, to medical devices and, in particular, to analytical test strips and related methods.

### BACKGROUND OF THE INVENTION

The determination (e.g., detection and/or concentration measurement) of an analyte in a fluid sample is of particular interest in the medical field. For example, it can be desirable to determine glucose, ketone bodies, cholesterol, lipoproteins, triglycerides, and/or HbA1c concentrations in a sample of a bodily fluid such as urine, blood, plasma or interstitial fluid. Such determinations can be achieved using analytical test strips, based on, for example, visual, photometric or electrochemical techniques. Conventional electrochemical-based analytical test strips are described in, for example, U.S. Pat. Nos. 5,708,247, and 6,284,125, each of which is hereby incorporated in full by reference.

### SUMMARY OF INVENTION

In a first aspect of the present invention there is provided an electrochemical-based analytical test strip for the determination of an analyte in a bodily fluid sample, the electrochemical-based analytical test strip comprising: an electrically insulating substrate; at least one patterned conductor layer disposed over the electrically-insulating substrate, the patterned conductive layer including: at least one analyte working electrode; at least one bare interferent electrode; and a shared counter/reference electrode; an enzymatic reagent layer disposed on the at least one analyte working electrode and the shared counter/reference electrode; and a patterned spacer layer, wherein the patterned spacer layer defines a sample receiving chamber with a sample-receiving opening, and wherein the at least one bare interferent electrode and the shared counter/reference electrode constitute a first electrode pair configured for measurement of an interferent electrochemical response; and wherein the at least one analyte working electrode and the shared counter/reference electrode constitute a second electrode pair configured for measurement of an analyte electrochemical response; and wherein the at least one analyte working electrode and the at least one bare interferent electrode are electrically isolated from one another.

The at least one bare interferent electrode may include a first bare interferent electrode and a second bare interferent electrode.

The at least one analyte working electrode may include a first analyte working electrode and a second analyte working electrode.

The ratio of an area of the analyte working electrode to an area of the bare interferent electrode may be approximately 2.4.

The analyte may be glucose and the bodily fluid sample may be blood.

The first electrode pair may be configured for measurement of an interferent electrochemical response generated at least in part by uric acid in the bodily fluid sample.

The first electrode pair may be configured for measurement of an interferent electrochemical response generated at least in part by acetaminophen in the bodily fluid sample.

The electrochemical-based analytical test strip may include a single patterned conductor layer disposed on the electrically insulating substrate such that the at least one analyte working electrode, bare interferent electrode and shared counter/reference electrode are in a planar configuration.

The at least one analyte working electrode and shared counter/reference electrode may be in a co-facial configuration.

The bare interferent electrode may have a surface that has been modified for increased surface activity.

In a second aspect of the present invention there is provided a method for determining an analyte in a bodily fluid sample, the method comprising: applying a bodily fluid sample containing at least one interferent to an electrochemical-based analytical test strip with at least one analyte working electrode covered by an enzymatic reagent layer and at least one bare interferent electrode, the at least one analyte working electrode and at least one bare interferent electrode being electrically isolated from one another; measuring an electrochemical response of the bare interferent electrode and an uncorrected electrochemical response of the analyte working electrode; correcting the measured uncorrected electrochemical response of the analyte working electrode based on the electrochemical response of the bare interferent electrode using an algorithm to create a corrected electrochemical response of the analyte working electrode; and determining the analyte based on the corrected electrochemical response.

The bodily fluid sample may be whole blood.

The at least one interferent may be uric acid and the correcting step may correct the uncorrected electrochemical response for the presence of uric acid in the bodily fluid sample.

The at least one interferent may be acetaminophen and the correcting step may correct the uncorrected electrochemical response for the presence of acetaminophen in the bodily fluid sample.

The algorithm may have the form:

I=I_{GE}−(α•I_{IE})

where:
I is corrected current of the glucose electrode;
I_{GE} is measured current of the glucose electrode;
I_{IE} is measured current of the interference electrode; and
   α is a correction factor.

The correction factor may have a positive value greater than zero.

The correction factor may be approximately 2.4.

The electrochemical response of the bare interferent electrode may be a current and the uncorrected electrochemical response of the analyte working electrode may be a current.

The electrochemical-based analytical test strip may further include a shared counter/reference electrode and the at least one analyte working electrode, shared counter/reference electrode and at least one bare interferent electrode are in a planar configuration.

The electrochemical-based analytical test strip may further include a shared counter/reference electrode and the at least one analyte working electrode and shared counter/reference electrode are in an opposing configuration.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention, in which:

FIG. 1 is a simplified exploded view of an electrochemical-based analytical test strip according to an embodiment of the present invention with the dashed lines indicating alignment of various layers thereof;

FIG. 2 is a simplified perspective view of the electrochemical-based analytical test strip of FIG. 1;

FIG. 3 is a simplified top view of the patterned conductor layer of the electrochemical-based analytical test strip of FIG. 1;

FIG. 4 is a simplified top view of a portion of the patterned conductor layer of FIG. 3 with non-limiting dimensions indicated;

FIG. 5 is a graph of current transients (i.e., electrochemical responses) measured on an electrochemical-based analytical test strip according to the present invention;

FIGS. 6A-6C are graphs of electrochemical response (i.e., electrode current at 5-second test time) of a bare interferent electrode of an electrochemical-based analytical test strip according to the present invention versus glucose and uric acid concentrations of a bodily fluid sample; and

FIG. 7 is a flow diagram depicting stages in a method for determining an analyte in a bodily fluid sample according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, electrochemical-based analytical test strips for the determination of an analyte (such as glucose) in a bodily fluid sample (for example, whole blood) according to embodiments of the present invention include an electrically insulating substrate, at least one patterned conductor layer disposed over the electrically-insulating substrate with the patterned conductor layer(s) having an analyte working electrode, a bare interferent electrode and a shared counter/reference electrode. The electrochemical-based analytical test strip also includes an enzymatic reagent layer disposed on the analyte working electrode and shared counter/reference electrode (but not on the bare interferent electrode), and a patterned spacer layer. In addition, the patterned spacer layer defines a sample-receiving chamber with a sample-receiving opening. Moreover, the bare interferent electrode and the shared counter/reference electrode constitute a first electrode pair configured for measurement of an interferent electrochemical response and the analyte working electrode and the shared counter/reference electrode constitute a second electrode pair configured for measurement of an analyte electrochemical response. Furthermore, the working electrode and the bare interferent electrode are electrically isolated (i.e., physically separate on the electrically insulating substrate) from one another.

The bare interferent electrode(s), analyte working electrode(s) and shared counter/reference electrode can be configured in a suitable planar configuration or a suitable co-facial (i.e., opposing) configuration. In a typical but non-limiting planar configuration, a single patterned conductor layer disposed on the electrically insulating substrate includes all of the aforementioned electrodes. In such a planar configuration, the analyte working, bare interferent and shared counter/reference electrodes are in a single plane on the surface of the electrically insulating substrate. In a typical but non-limiting co-facial configuration, the analyte working electrode and shared counter/reference electrode are in an opposing relationship with, for example, the analyte working electrode being disposed on the electrically insulating substrate layer and the shared counter/reference electrode being disposed on an underside of a layer that is above the electrically insulating substrate layer.

It is noted that the term “bare interferent electrode” refers to an interferent electrode that is devoid of any electrochemically active entities (i.e., a chemical entity is capable of undergoing an electrochemical reaction to generate a response at the interferent electrode such as, for example, an enzyme or mediator) on its surface or in close operative vicinity to the interferent electrode. However, a bare interferent electrode can, if desired, have a surface that is modified by, for example, a suitable plasma treatment, to increase the surface activity of the bare interferent electrode. It is also noted that the term “electrode pair” refers to two electrodes configured to provide a desired electrochemical response linearity, sensitivity and range. In this regard, the areas of the shared counter/reference and analyte working electrodes in the second electrode pair are predetermined such that the electrochemical response of the second electrode pair is not limited by the area of the shared counter/reference electrode. Moreover, the areas of the shared counter/reference electrode and bare interferent electrode in the first electrode pair must also be predetermined such that the electrochemical response of the first electrode pair is not limited by the area of the shared counter/reference electrode.

The determination accuracy of electrochemical-based analytical test strips can suffer from interferents (i.e., substances in bodily fluid samples that confound the determination due to the generation of “interfering” electrochemical-responses (e.g., an interfering current) at a working electrode. Because the “interfering” electric signals are not generated from the enzymatic reactions involving the target analyte (e.g., glucose), the test results normally lead to a false high analyte concentration reading. Uric acid, ascorbic acid and acetaminophen are common interferents in the electrochemical-based determination of glucose in a bodily fluid sample. In various embodiments according to the present invention, the affect of interfering substances is mitigated by using at least one bare interferent electrode to measure the interfering electrochemical response and then using an algorithm to correct a measured electrochemical response from an analyte working electrode by compensating for the interfering substance's contribution to the measured electrochemical response at the analyte working electrode. In this regard, the term “bare” refers to the absence of any mediator or enzyme on the surface of the electrode.

Electrochemical-based analytical test strips according to embodiments of the present invention are beneficial in that, for example, (i) the bare interferent electrodes produce a direct electrochemical-response for a number of relevant interferents and not just a targeted individual interferent; (ii) the interferent electrodes can be formed from the same conducting layer used to form the analyte working electrode(s) and shared counter/reference electrode, thus simplifying the manufacturing process and reducing cost; and (iii) since the bare interferent electrode(s) is physically separate from the analyte working electrode(s), the bare interferent electrode(s) does not present any detrimental risk to the performances (e.g., sensitivity, linearity, stability, precision, etc.) of the analyte working electrode(s).

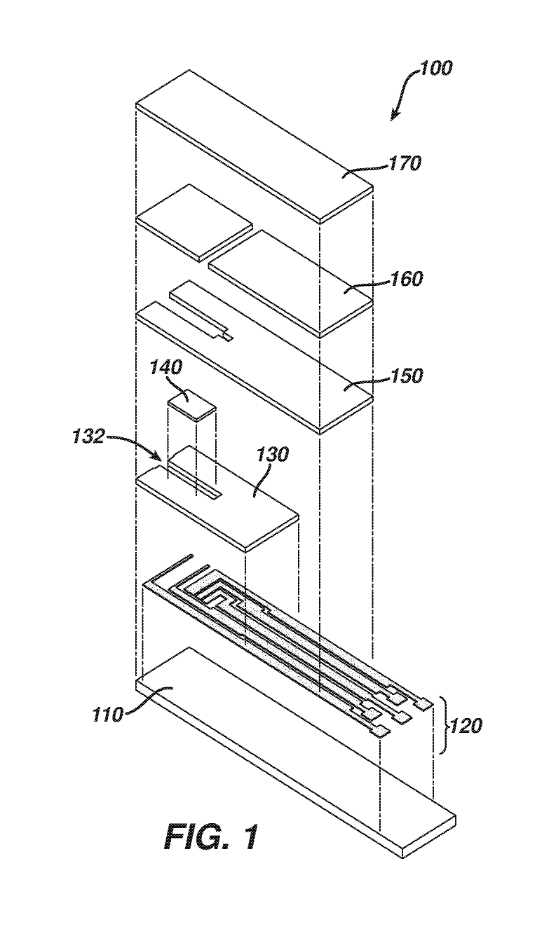

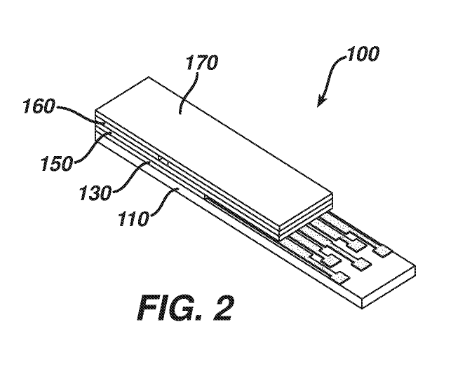

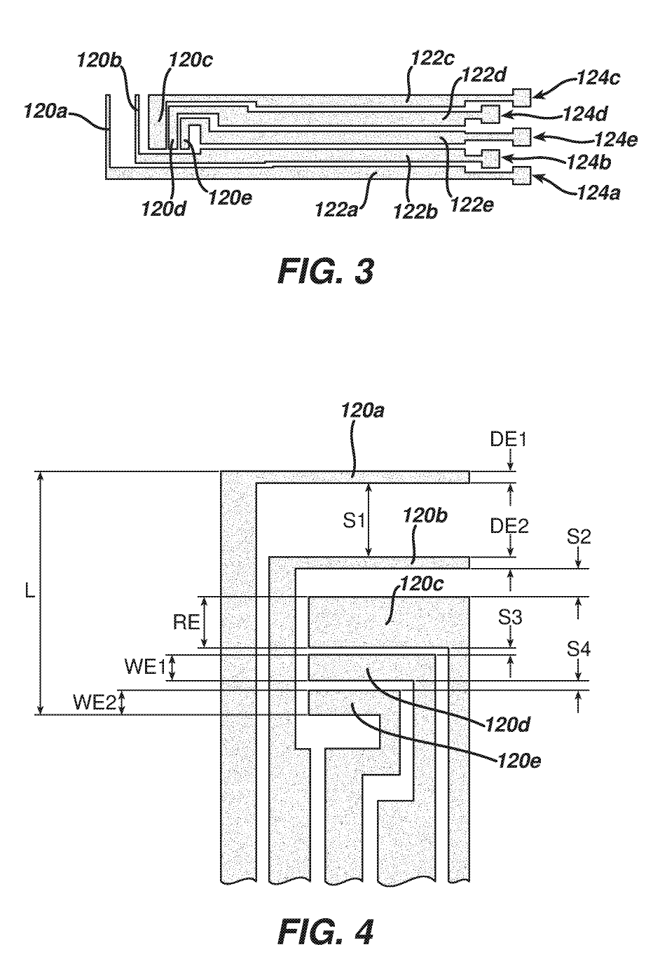

FIG. 1 is a simplified exploded view of an electrochemical-based analytical test strip 100 according to an embodiment of the present invention with the dashed lines indicating alignment of various layers thereof. FIG. 2 is a simplified perspective view of electrochemical-based analytical test strip 100. FIG. 3 is a simplified top view of a patterned conductor layer of electrochemical-based analytical test strip 100 of FIG. 1. FIG. 4 is a simplified top view of a portion of the patterned conductor layer of FIG. 3.

Referring to FIGS. 1 through 4, electrochemical-based analytical test strip 100 for the determination of an analyte (such as glucose) in a bodily fluid sample (for example, a whole blood sample) includes an electrically-insulating substrate 110, a patterned conductor layer 120, a patterned insulation layer 130 with electrode exposure slot 132 therein, an enzymatic reagent layer 140, a patterned spacer layer 150, a patterned hydrophilic layer 160, and a top layer 170.

The disposition and alignment of electrically-insulating substrate 110, patterned conductor layer 120 (which includes a first bare interferent electrode 120a, a second bare interferent electrode 120b, a shared counter/reference electrode 120c, a first analyte working electrode 120d and a second analyte working electrode 120e, see FIGS. 3 and 4 in particular), patterned insulation layer 130, enzymatic reagent layer 140, patterned spacer layer 150, patterned hydrophilic layer 160 and top layer 170 of electrochemical-based analytical test strip 100 are such that sample-receiving chamber is formed within electrochemical-based analytical test strip 100. In addition to the aforementioned electrodes, patterned conductor layer 120 also includes a plurality of electrical tracks 122a-122e and electrical connection pads 124a-124e, with the electrical connection pads being configured for operable electrical contact with an associated test meter (see FIG. 3 in particular).

Although electrochemical-based analytical test strip 100 is depicted as including two bare interferent electrodes and two analyte working electrodes, embodiments of electrochemical-based analytical test strips, including embodiments of the present invention, can include any suitable number of bare interferent electrodes and analyte working electrodes. However, the inclusion of two bare interferent electrodes enables a beneficial comparison of the electrochemical responses of each of these bare interferent electrodes to verify that the bare interferent electrodes are essentially defect free and that the electrochemical responses are the result of proper use of the electrochemical-based analytical test strip. For example, the absolute bias between the electrochemical response of the two bare interferent electrodes or the ratio of the two electrochemical responses can be compared to a predetermined threshold for verification purposes.

First bare interferent electrode 120a, second bare interferent electrode 120b, shared counter/reference electrode 120c, first analyte working electrode 120d, and second analyte working electrode 120e, as well as the remainder of patterned conductor layer 120, can be formed of any suitable material(s) including, for example, gold, palladium, platinum, indium, titanium-palladium alloys and electrically conducting carbon-based materials including electrically conductive graphite materials. An exemplary but non-limiting material for patterned conductor layer 120 is a screen-printable conductive ink commercially available as DuPont 7240 Screen Printable Polymeric Carbon Conductor.

Referring to FIG. 4, exemplary non-limiting dimensions for the various electrodes and the spacing therebetween of electrochemical-based analytical test strip 100 are L=4.82 mm; DE1 and DE2=0.20 mm; RE=0.96 mm; WE1 and WE2=0.48 mm; S1=1.5 mm; S2=0.60 mm; S3 and S4=0.20 mm.

In electrochemical-based analytical test strips according to the present invention, the spacing between a bare interferent electrode and the shared counter/reference electrode (such as dimension S2 in FIG. 4) is predetermined such that electrochemically active entities in the enzymatic reagent layer cannot travel to the surface of the bare interferent electrode by, for example, diffusion or bodily fluid sample flow during operable use of the electrochemical-based analytical test strip. This spacing will, therefore, be dependent on a variety of factors including the hydration, dissolution and diffusion characteristics of the enzymatic reagent layer and electrochemically active entities therein, test duration and characteristics of the bodily fluid sample such as viscosity and temperature.

During use, a bodily fluid sample is applied to electrochemical-based analytical test strip 100 and transferred to the sample-receiving chamber thereof, thereby operatively contacting first bare interferent electrode 120a, second bare interferent electrode 120b, shared counter/reference electrode 120c, first analyte working electrode 120d and second analyte working electrode 120e.

Electrically-insulating substrate 110 can be any suitable electrically-insulating substrate known to one skilled in the art including, for example, a glass substrate, a ceramic substrate, a nylon substrate, polycarbonate substrate, a polyimide substrate, a polyvinyl chloride substrate, a polyethylene substrate, a polypropylene substrate, a glycolated polyester (PETG) substrate, or a polyester substrate. An exemplary but non-limiting example of an electrically-insulating substrate material is a polyester sheet material commercially available as Melinex ST328 from DuPont. The electrically-insulating substrate can have any suitable dimensions including, for example, a width dimension of about 5 mm, a length dimension of about 27 mm and a thickness dimension of about 0.5 mm.

Electrically-insulating substrate 110 provides structure to the strip for ease of handling and also serves as a base for the application (e.g., printing or deposition) of subsequent layers (e.g., a patterned conductor layer). It should be noted that patterned conductor layers employed in analytical test strips according to embodiments of the present invention can take any suitable shape and be formed of any suitable materials including, for example, metal materials and conductive carbon materials.

Electrode exposure slot 132 of patterned insulation layer 130 is configured to leave the electrodes of patterned conductor layer 120 exposed. The insulation layer can be formed from any dielectric material, e.g., a screen-printable polymer-based insulation ink. Such a screen-printable insulating ink is commercially available from Ercon of Wareham, Massachusetts U.S.A. as Ercon E6110-116 Jet Black Insulayer ink.

Patterned spacer layer 150 defines a sample-receiving chamber with a height in the range of 110 microns to 150 microns and a width in the range of 1.0 mm to 1.5 mm). Patterned spacer layer 150 is configured to leave the electrodes of patterned conductor layer 120 exposed and can be created (i) from a pre-formed double-sided adhesive tape (e.g., ETT Vita Top Tape available commercially from Tape Specialities Ltd), (ii) by directly depositing (e.g., screen-printing) an adhesive layer (e.g., by screen-printing an adhesive ink such as A6435 Screen Printable Adhesive from Tape Specialities Ltd.), or from a screen-printable pressure sensitive adhesive commercially available from Apollo Adhesives, Tamworth, Staffordshire, UK. In the embodiment of FIG. 1, patterned spacer layer 150 defines outer walls of the sample-receiving chamber.

In the embodiment of FIGS. 1-4, patterned hydrophilic layer 160 has a 1.0 mm wide gap 162 that serves as an air vent during use of electrochemical-based analytical test strip 100. The patterned hydrophilic layer can, if desired, be transparent so that flow of a bodily fluid sample in the sample-receiving chamber can be viewed upon testing. Hydrophilic layer 160 can be, for example, a clear film with hydrophilic properties that promote wetting and filling of electrochemical-based analytical test strip 100 by a fluid sample (e.g., a whole blood sample). Such clear films are commercially available from, for example, 3M of Minneapolis, Minn. U.S.A.

An electrically non-conductive top layer attached (e.g., by adhesion) to the outer side of the spacer to form an air vent in conjunction with the spacer. It can be made of any electrically insulating materials, such as plastic sheets/films. Ideally it is transparent to allow visualization of fluidic sample movement in the sample-receiving chamber. An example top layer is Ultra Plus Top Tape (from Tape Specialities Ltd).

If desired, patterned spacer layer 150, patterned hydrophilic layer 160 and top layer 170 can be integrated into a single component prior to assembly of electrochemical-based analytical test strip 100. Such an integrated component is also referred to as an Engineered Top Tape (ETT).

Enzymatic reagent layer 140 can include any suitable enzymatic reagents, with the selection of enzymatic reagents being dependent on the analyte to be determined. For example, if glucose is to be determined in a blood sample, enzymatic reagent layer 140 can include a glucose oxidase or glucose dehydrogenase along with other components necessary for functional operation. Enzymatic reagent layer 140 can include, for example, glucose oxidase, tri-sodium citrate, citric acid, polyvinyl alcohol, hydroxyl ethyl cellulose, potassium ferricyanide, antifoam, silica, PVPVA, and water. Further details regarding enzymatic reagent layers, and electrochemical-based analytical test strips in general, are in U.S. Pat. Nos. 5,708,247, 6,241,862 and 6,733,655, the contents of which are hereby fully incorporated by reference. Enzymatic reagent layer 140 fully covers the analyte working electrodes and the shared counter/reference electrode but is not disposed on the bare interferent electrodes.

Electrochemical-based analytical test strip 100 can be manufactured, for example, by the sequential aligned formation of patterned conductor layer 120, patterned insulation layer 130, enzymatic reagent layer 140, patterned spacer layer 150, hydrophilic layer 160 and top layer 170 onto electrically-insulating substrate 110. Any suitable techniques known to one skilled in the art can be used to accomplish such sequential aligned formation, including, for example, screen printing, photolithography, photogravure, chemical vapour deposition and tape lamination techniques.

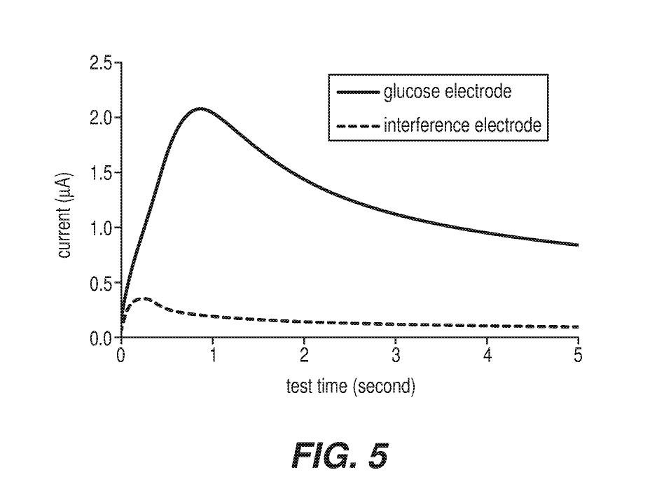

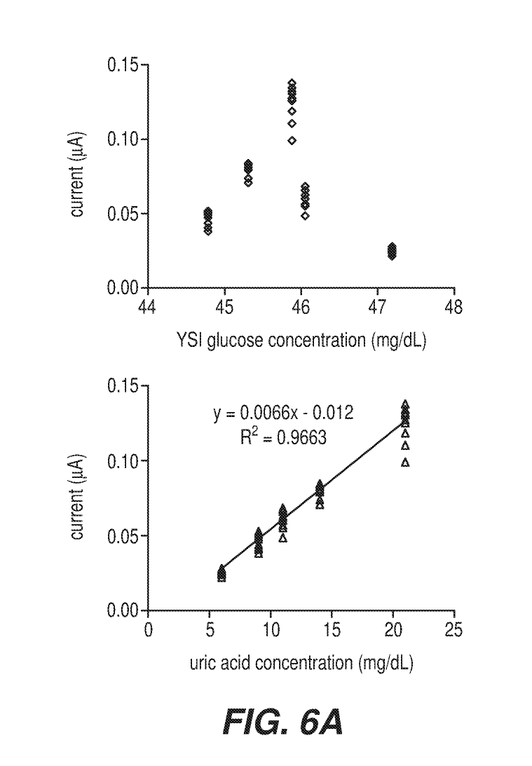

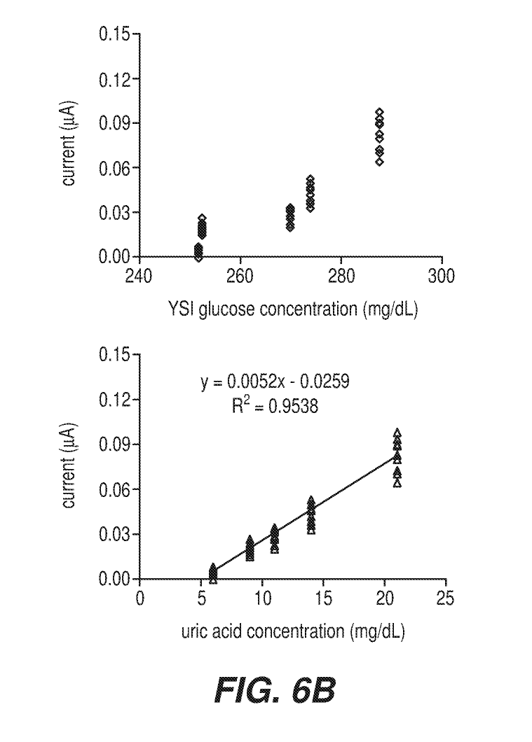

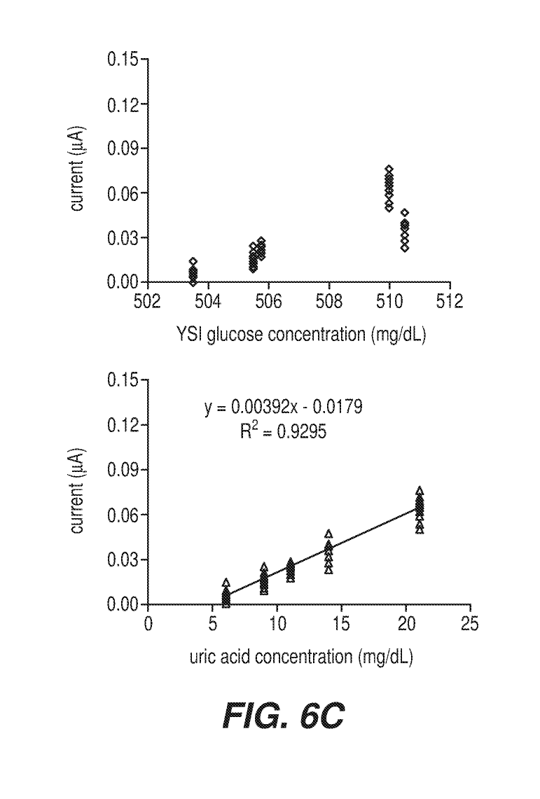

FIG. 5 is a graph of current transients (i.e., electrochemical responses) measured on an electrochemical-based analytical test strip according to the present invention. FIGS. 6A-6C are graphs of electrochemical response (i.e., electrode current at 5-second test time) of an interferent electrode of an electrochemical-based analytical test strip according to the present invention versus glucose and uric acid concentrations of a bodily fluid sample. Beneficial characteristics and use of electrochemical-based analytical test strips with bare interferent electrode(s) according to embodiments of the present are evident and described via the test results discussed below and depicted in FIGS. 5 and 6A through 6C.

Referring to FIG. 5, for experimental purposes a single bare interferent electrode (also referred to as an interference electrode) and one glucose analyte working electrode were coupled separately with a shared counter/reference electrode of an electrochemical-based analytical test strip essentially as depicted in FIG. 1 to form two electrode pairs for interferent measurement and glucose measurement, respectively. The measurement currents of the two electrode pairs were recorded using a test instrument with 0.4V potential applied throughout 5 seconds (i.e., no poise delay was employed).

One batch of electrochemical-based analytical strips according to the present invention and two donor human blood samples were used for additional experimentation. The blood samples from donor 1 and donor 2 had Hct values of 41.3% and 41.8% respectively. The uric acid concentration of donor 1 and donor 2 blood samples before sample manipulation (i.e., uric acid and glucose spiking) were 5.97 and 5.42 mg/dL, respectively.

FIG. 5 shows typical measurement transients of the two types of electrode pairs on an electrochemical-based analytical test strip. The recorded current signal of the bare interference electrode is lower than that of the glucose analyte working electrode throughout the 5 second measurement because of their difference in surface areas exposed to the blood (see FIG. 4 in particular) and their different surface characteristics (i.e., a bare interferent electrode and an enzymatic reagent layer coated analyte working electrode).

For the test using donor 1 blood sample, FIGS. 6A, 6B and 6C depict 3 pairs of plots of 5-second current of the interferent electrode vs uric acid concentration and YSI plasma glucose concentration, respectively at 3 different glucose concentration ranges (each pair of the plots are prepared by using the same set of current data, but are plotted against concentration of the two different components of the blood). The YSI glucose concentration values in the FIGs. are averages of 4 glucose readings of plasma prepared from the blood samples obtained using a YSI 2300 STAT Plus Glucose Analyzer commercially available from Yellow Springs (Ohio, USA).

FIGS. 6A-6C indicate a good linear correlation between the current electrochemical response of the bare interferent electrode and uric acid concentration whilst that current does not increase with increased glucose concentration. These results indicate that the increase in electrochemical response of the bare interferent electrode is predominantly attributed to increased concentration of the interferent (uric acid) with negligible contribution from glucose.

Further experimentation has shown that the accuracy of glucose determination in the presence of the interferents uric acid and acetaminophen is significantly improved by use of electrochemical-based analytical test strips according to the present invention along with application of the following algorithm to measured 5 second current electrochemical-responses:

I=I_{GE}−(α•I_{IE}) (1)

where:
I is corrected current of the glucose electrode;
I_{GE} is measured current of the glucose electrode
I_{IE} is measured current of the interferent electrode;
α is a positive non-zero correction factor which depends on strip design (e.g., size of the two electrodes, reagent layer of the glucose electrode, etc.) and the measurement setups (e.g., applied potentials for the two electrodes, measurement time of the two electrodes, etc.).

For purposes of these experiments, an a value of 2.4 (i.e., the surface area ratio of the glucose analyte working electrode to the bare interference electrode) was employed.

Equation (1) is a non-limiting example for how interference can be compensated by using the measured currents of the interference electrode and the glucose electrode. Once apprised of the present disclosure, one skilled in the art can develop other algorithms for the benefit of measurement accuracy improvement.

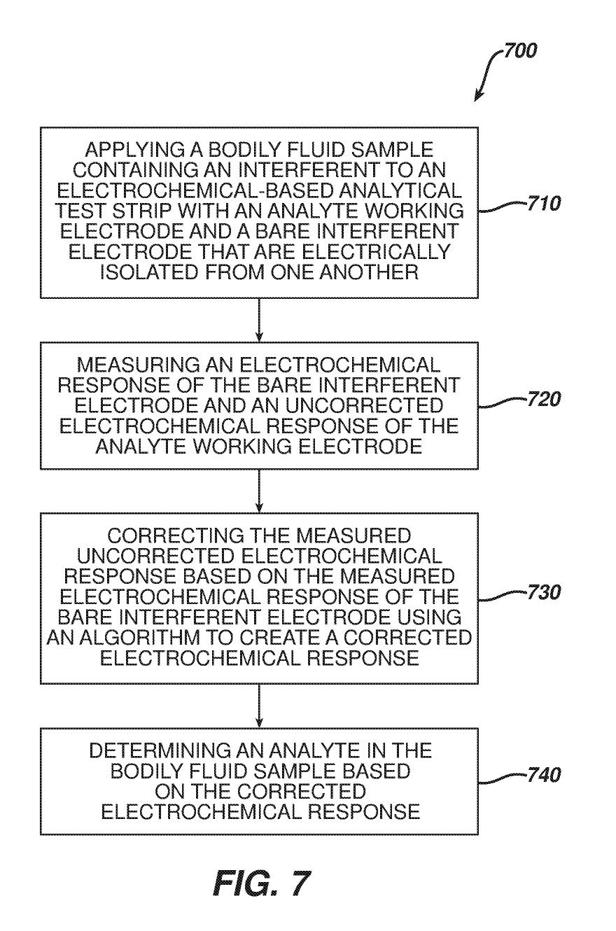

FIG. 7 is a flow diagram depicting stages in a method 700 for determining an analyte (such as glucose) in a bodily fluid sample according to an embodiment of the present invention. At step 710 of method 700, a bodily fluid sample containing at least one interferent (such as uric acid and/or acetaminophen and/or ascorbic acid) is applied to an electrochemical-based analytical test strip having at least one analyte working electrode covered by an enzymatic reagent layer and at least one bare interferent electrode. In addition, the at least one working analyte electrode and at least one bare interferent electrode being electrically isolated from one another.

At step 720, an electrochemical response (such as an electrochemical response current) of the bare interferent electrode and an uncorrected electrochemical response (such as an uncorrected electrochemical response current) of the analyte working electrode are measured. The electrochemical response of the bare interferent electrode can be in series, in parallel or in an overlapping manner with the measurement of the uncorrected electrochemical response of the analyte working electrode. The applied potential for measuring the electrochemical response of the bare interferent electrode can be the same as that applied for measuring the uncorrected electrochemical response of the analyte working electrode (e.g., 0.4V) or different. It is noted that in the determination of glucose in a bodily fluid sample by embodiments of the present invention, the electrochemical response (e.g., current) of the bare interferent electrode is predominantly originates from direct oxidation of interferents (e.g., uric acid, ascorbic acid, etc.) in the bodily fluid sample (e.g., a whole blood sample) whilst the uncorrected electrochemical response measurement current of the analyte (glucose) working electrode mainly results from redox reactions involving both glucose and the interferents.

Subsequently, the measured uncorrected electrochemical response of the analyte working electrode is corrected based on the measured electrochemical response of the bare interferent electrode using an algorithm (such as equation (1) described below) to create a corrected electrochemical response of the analyte working electrode (see step 730 of FIG. 7).

When the uncorrected electrochemical response of the analyte working electrode and the electrochemical response of the bare interferent electrode are both electrical currents, the corrected electrochemical response (also a current) can be calculated in method according to the present invention using the following algorithm:

I=I_{GE}−(α•I_{IE})

where:
I is corrected current of the glucose electrode;
I_{GE} is the measured uncorrected current of the glucose electrode
I_{IE} is measured current of the interference electrode;
α a is a positive non-zero correction factor which depends on strip design (e.g., size of the two electrodes, reagent layer of the glucose electrode, etc.) and that can also, if desired, be empirically or semi-empirically determined based on clinical data.

At step 740, the analyte is determined based on the corrected electrochemical response.

The measuring, correcting and determination steps (i.e., steps 720, 730 and 740) can, if desired, by performed using a suitable associated test meter configured to make operative electrical connection to the electrochemical-based analytical test strip.

Once apprised of the present disclosure, one skilled in the art will recognize that method 700 can be readily modified to incorporate any of the techniques, benefits and characteristics of electrochemical-based analytical test strips according to embodiments of the present invention and described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

1.-20. (canceled)

21. An electrochemical-based analytical test strip for the determination of an analyte in a bodily fluid sample, the electrochemical-based analytical test strip comprising:
an electrically insulating substrate;
at least one patterned conductor layer disposed over the electrically-insulating base layer, the patterned conductive layer including:
at least one analyte working electrode;
at least one bare interferent electrode; and
a shared counter/reference electrode;
an enzymatic reagent layer disposed on the at least one analyte working electrode and the shared counter/reference electrode; and
a patterned spacer layer,
wherein the patterned spacer layer defines a sample receiving chamber with a sample-receiving opening, and
wherein the at least one bare interferent electrode and the shared counter/reference electrode constitute a first electrode pair configured for measurement of an interferent electrochemical response; and
wherein the at least one analyte working electrode and the shared counter/reference electrode constitute a second electrode pair configured for measurement of an analyte electrochemical response; and
wherein the at least one analyte working electrode and the at least one bare interferent electrode are electrically isolated from one another.

22. The electrochemical-based analytical test strip of claim 21 wherein the at least one bare interferent electrode includes a first bare interferent electrode and a second bare interferent electrode.

23. The electrochemical-based analytical test strip of claim 22 wherein the at least one analyte working electrode includes a first analyte working electrode and a second analyte working electrode.

24. The electrochemical-based analytical test strip of claim 21 wherein a ratio of an area of the analyte working electrode to an area of the bare interferent electrode is approximately 2.4.

25. The electrochemical-based analytical test strip of claim 21 wherein the analyte is glucose and the bodily fluid sample is blood.

26. The electrochemical-based analytical test strip of claim 21 wherein the first electrode pair is configured for measurement of an interferent electrochemical response generated at least in part by uric acid in the bodily fluid sample.

27. The electrochemical-based analytical test strip of claim 21 wherein the first electrode pair is configured for measurement of an interferent electrochemical response generated at least in part by acetaminophen in the bodily fluid sample.

28. The electrochemical-based analytical test strip of claim 21 including a single patterned conductor layer disposed on the electrically insulating substrate such that the at least one analyte working electrode, bare interferent electrode and shared counter/reference electrode are in a planar configuration.

29. The electrochemical-based analytical test strip of claim 21 wherein the at least one analyte working electrode and shared counter/reference electrode are in a co-facial configuration.

30. The electrochemical-based analytical test strip of claim 21 wherein the bare interferent electrode has a surface that has been modified for increased surface activity.

31. A method for determining an analyte in a bodily fluid sample, the method comprising:
applying a bodily fluid sample containing at least one interferent to an electrochemical-based analytical test strip with at least one analyte working electrode covered by an enzymatic reagent layer and at least one bare interferent electrode, the at least one working analyte electrode and at least one bare interferent electrode being electrically isolated from one another;
measuring an electrochemical response of the bare interferent electrode and an uncorrected electrochemical response of the analyte working electrode;
correcting the measured uncorrected electrochemical response of the analyte working electrode based on the electrochemical response of the bare interferent electrode using an algorithm to create a corrected electrochemical response of the analyte working electrode; and
determining the analyte based on the corrected electrochemical response.

32. The method of claim 31 wherein the bodily fluid sample is whole blood.

33. The method of claim 31 wherein the at least one interferent is uric acid and the correcting step corrects the uncorrected electrochemical response for the presence of uric acid in the bodily fluid sample.

34. The method of claim 31 wherein the at least one interferent is acetaminophen and the correcting step corrects the uncorrected electrochemical response for the presence of acetaminophen in the bodily fluid sample.

35. The method of claim 31 wherein the algorithm has the form:
I=I_{GE}−(α•I_{IE})
where:
I is corrected current of the glucose electrode;
I_{GE} is measured current of the glucose electrode;
I_{IE} is measured current of the interference electrode; and
α is a correction factor.

36. The method of claim 35 wherein the correction factor has a positive non-unity value greater than zero.

37. The method of claim 35 wherein the correction factor is approximately 2.4.

38. The method of claim 31 wherein the electrochemical response of the bare interferent electrode is a current and the uncorrected electrochemical response of the analyte working electrode is a current.

39. The method of claim 31 wherein the electrochemical-based analytical test strip further includes a shared counter/reference electrode and the at least one analyte working electrode, shared counter/reference electrode and at least one bare interferent electrode are in a planar configuration.

40. The method of claim 31 wherein the electrochemical-based analytical test strip further includes a shared counter/reference electrode and the at least one analyte working electrode and shared counter/reference electrode are in an opposing configuration.
